(19) United States
(12) Patent Application Publication
(10) Pub. No.: US 2024/0408851 A1
(43) Pub. Date: Dec. 12, 2024

(54) TRANSPARENT LAMINATED PANE WITH INCREASED RESISTANCE TO PROJECTILES WITH A HARD METAL CORE

(71) Applicant: FRAUNHOFER-GESELLSCHAFT ZUR FÖRDERUNG DER ANGEWANDTEN FORSCHUNG E. V., München (DE)

(72) Inventor: Elmar Strassburger, Freiburg im Breisgau (DE)

(21) Appl. No.: 18/701,992

(22) PCT Filed: Oct. 25, 2022
(86) PCT No.: PCT/EP2022/079781

§ 371 Date: Apr. 17, 2024

(30) Foreign Application Priority Data
Oct. 26, 2021 (DE) 10 2021 127 755.8

(51) Int. Cl. B32B 17/10; B32B 9/00; B32B 9/04; B32B 27/08; B32B 27/36; B60J 1/00; B60J 1/20; F41H 5/04

(52) U.S. Cl. CPC B32B 17/10018; B32B 9/005; B32B 9/045; B32B 17/10752; B32B 27/08; B32B 27/365; B60J 1/001; B60J 1/2094; F41H 5/0407; B32B 2307/412; B32B 2307/7376; B32B 2571/02

(57) ABSTRACT

The present invention relates to transparent laminated panes for security applications, which comprise a laminate made up of transparent layers of a compartmentalized construction, with two blocks separated from one another by a gas-filled intermediate space, wherein the layer of the second block, which is in contact with the gas-filled intermediate space, comprises transparent ceramic, and relates to the use thereof for security and/or protection applications for panes or windows in civilian and military areas.

The present invention relates to transparent laminated sheets for security applications which comprise a laminate of transparent layers in compartmentalized construction, the two blocks separated from one another by a gas-filled compartment, where the layer of the second block with contact to the gas-filled compartment comprises transparent ceramic.

### TECHNICAL BACKGROUND

Security windows, especially as transparent protection inhibiting ballistic penetration, and especially for vehicles and flying objects, are subject to continually rising requirements for lower weight or—with a view to the space taken up—for thinner sheets, while at the same time the security need is growing. Traditionally known armored glass windows are not able to meet these requirements for all deployment scenarios, and so for around 20 years there have been broad international developments known in relation to the substitution particularly of the outer lamina (or laminas) of stratified laminated windows by transparent mono- or polycrystalline ceramic materials.

The effect of transparent ceramics against projectile cores made of cemented carbide such as tungsten carbide, for example, is much less than against steel cores. When a steel projectile strikes a ceramic at high velocity, the projectile is greatly deformed and loses a large fraction of its mass through erosion on interaction with the ceramic. This phenomenon can be observed even for low ceramic thicknesses. Tungsten carbide cores are fragmented to much less of an extent on interaction with transparent ceramics. In the case of transparent spinel ceramic, at thicknesses of material of up to 11 mm there is only minor erosion at the tip of the tungsten carbide cores. If the core material fails, only a few cracks and fragments are produced. Greater disintegration of the core is achievable only with thicker spinel plates. The objective, however, is to realize transparent protection against projectiles having a cemented carbide core (e.g., tungsten carbide) with as low a weight as possible.

In protective arrangements with transparent ceramic, a facing layer of transparent ceramic is used to achieve increased efficacy against projectiles having a hard core (hardened steel core or tungsten carbide core) by comparison with laminated safety glasses (laminates of glass layers and plastic layers).

U.S. Pat. No. 7,584,689 B2 describes laminated armoring consisting of a facing layer of transparent ceramic, glass sheets and plastic sheets, and the effect of this armoring against various types of small-caliber munitions with soft and hard cores, including a tungsten carbide core. Possible transparent ceramics identified are magnesium aluminate spinel (MgAl₂O₄), aluminum oxynitride (AlON), polycrystalline aluminum oxide (Al₂O₃) and sapphire (Al₂O₃ single crystal).

US 2009/0320675 A1 describes in particular the implementation of the ceramic layer in the form of a mosaic of many transparent ceramic plates and protective arrangements having two ceramic mosaic laminas with mutually offset joints.

DE 20 2008 014 264 U1 likewise describes ceramic-glass-plastic laminates with ceramic mosaic laminas, with ceramic tiles that are not square being among those used here.

In DE 10 2011 014100 A1, the focus is on the use of a refractive index-modified adhesive and the associated possibility of the embedment of ceramic parts with complex geometry.

WO 2013/017448 A1 shows the advantages of monocrystalline spinel over polycrystalline transparent ceramics and sapphire.

In all of the stated protective arrangements, the spinel ceramic was always used as a facing layer. Even in the case of compartmentalized constructions, the spinel ceramic was used as the facing layer of the first block.

Because of the much higher strength and hardness of the transparent ceramic by comparison with glasses, the yield point is exceeded, in the case of projectile cores made of hardened steel, when the ceramic is penetrated. One of the effects of this is to increase the interface between projectile and ceramic. Another is that projectile material erodes; in other words, there is a decrease in the mass of the projectile core. Furthermore, the projectile core is damaged further by fractures and the penetration capacity is reduced. On penetration of projectile cores made of tungsten carbide into transparent ceramic, the stated damage occurs only in a significantly weakened form and in dependence on the thickness of the ceramic lamina. Attaining the desired effect requires the use of thick laminas (12-14 mm) of transparent ceramic. This reduces the efficiency of these protective arrangements relative to their mass.

There is consequently a demand for protective arrangements which achieve effective protection with respect to projectiles having a cemented carbide core, such as tungsten carbide, are lightweight, and exhibit good weathering resistance.

### SUMMARY OF THE INVENTION

The present invention relates to a transparent laminated sheet for security applications, comprising
a laminate of transparent layers in compartmentalized construction that comprises two blocks separated from one another by a gas-filled compartment, wherein
the first block (A) comprises at least one transparent layer selected from glasses and/or plastics; and
the second block (B) comprises a laminate of at least two transparent layers selected from ceramics, glasses and/or plastics, where at least one layer of the second block (B) comprises transparent ceramic.

Additionally, the present invention relates to the use of the transparent laminated sheet as claimed in any of the preceding claims for security and/or protection applications for glazing or windows in the civil and military sectors.

### BRIEF DESCRIPTION OF THE FIGURES

FIGS. 1-4 show various embodiments of the transparent laminated sheet of the invention.

FIG. 1 shows an embodiment having a two-layer second block (B) with a layer of a plate of transparent ceramic joined to a layer of plastic.

FIG. 2 shows a further embodiment having a two-layer second block (B) with a layer of tessellated plates of transparent ceramic joined to a layer of plastic.

FIG. 3 shows an embodiment having a three-layer second block (B) with a layer of a plate of transparent ceramic joined to two conjoined layers of plastic.

FIG. 4 shows a further embodiment having a two-layer second block (B) with a layer of tessellated plates of transparent ceramic joined to two conjoined layers of plastic.

FIG. 5 shows a photo of a generic target construction (corresponding to the embodiment in FIG. 2) and x-ray flash exposure during projectile penetration.

FIG. 6 shows a photo of the polycarbonate plate of the second block after bombardment of joints.

### DETAILED DESCRIPTION OF THE INVENTION

The present invention relates to a transparent laminated sheet for security applications, comprising
a laminate of transparent layers in compartmentalized construction that comprises two blocks separated from one another by a gas-filled compartment, wherein
the first block (A) comprises at least one transparent layer selected from glasses and/or plastics; and
the second block (B) comprises a laminate of at least two transparent layers selected from ceramics, glasses and or plastics, where at least one layer of the second block (B) comprises transparent ceramic.

The terms transparent or transparency denote, as is known, a clear see-throughness, in delimitation from components that are only translucent.

The transparent laminated sheet of the invention comprises, preferably consists of, a laminate of transparent layers in compartmentalized construction that comprises two blocks separated from one another by a gas-filled compartment.

Besides the laminate of transparent layers in compartmentalized construction, the transparent laminated sheet may also comprise further transparent layers, including layers disposed in the laminate.

The transparent laminated sheet preferably consists of a laminate of transparent layers in compartmentalized construction.

The composite of transparent layers in compartmentalized construction comprises two blocks separated from one another by a gas-filled compartment.

Besides the two blocks separated from one another by a gas-filled compartment, the laminate may comprise one or more further blocks having one or more transparent layers.

The laminate preferably consists of the two blocks separated from one another by a gas-filled compartment.

The gas-filled compartment preferably has a thickness of 10 to 30 mm, more preferably of 15 mm to 25 mm.

The gas-filled compartment may be full of any non-flammable gas. Suitable gases are, for example, inert gases such as nitrogen, helium, neon, argon, krypton and xenon. Particularly suitable gases are those which are used in multiple glazing systems to attain good thermal insulation, such as argon, krypton and xenon, especially argon. In some embodiments, these gases make it possible to reduce the thermal load on the refractive index-modified adhesive layer.

The first block (A) comprises at least one lamina/layer selected from glasses and/or plastics.

The first block (A) preferably comprises a laminate of at least two, such as for example two, three, four or five, preferably two or three, most preferably two layers selected from glasses and/or plastics.

It is particularly preferred for the first block (A) to consist of a laminate of at least two, such as for example two, three, four or five, preferably two or three, most preferably two layers selected from glasses and/or plastics.

The first block (A) preferably comprises a laminate of at least one layer of glass and at least one layer of plastic, more preferably a laminate of one layer of glass and one layer of plastic.

It is particularly preferred for the outer layer of the first block (A) with contact to the gas-filled compartment to be a layer of plastic.

It is additionally particularly preferred for the outer layer of the first block (A) without contact to the gas-filled compartment to be a layer of glass.

The first block (A) preferably contains no layer which comprises transparent ceramic.

The first block (A) preferably has a thickness of 5 to 20 mm, more preferably of 5 mm to 10 mm.

The second block (B) comprises a laminate of at least two transparent layers selected from ceramics, glasses and or plastics, where at least one layer of the second block (B) comprises transparent ceramic.

The second block (B) preferably comprises the at least one layer which comprises transparent ceramic, and at least one layer of glass or of plastic.

The second block (B) preferably comprises a laminate of two to ten, such as for example two, three, four, five or six, preferably two, three or four, most preferably two layers selected from ceramics, glasses and/or plastics.

It is particularly preferred for the second block (B) to consist of a laminate of at least two, such as two to ten, such as for example two, three, four, five or six, preferably two, three or four, most preferably two layers selected from ceramics, glasses and/or plastics.

At least one, such as for example one to three, preferably one or two, most preferably one layer of the second block (B) comprises transparent ceramic.

It is preferred for the layer of the second block (B) with contact to the gas-filled compartment to comprise transparent ceramic.

The at least one layer of the second block (B) which comprises transparent ceramic is preferably composed of a plate of transparent ceramic or of tessellated or serialized plates of transparent ceramic.

The tessellated or serialized plates of transparent ceramic are preferably joined to one another by an adhesion-promoting joining means, preferably having a refractive index matched to the transparent ceramic.

Examples of an arrangement of tessellated or serialized plates of transparent ceramic are described in U.S. Pat. No. 7,584,689 B2, US 2009/0320675 A1 or DE 20 2008 014 264 U1. One or more such tessellated or serialized plates may also be processed into a larger window.

A layer of the second block (B) which comprises transparent ceramic preferably has a thickness of 5 to 15 mm.

The second block (B) preferably has a thickness of 30 to 60 mm. The thickness of the second block (B) is dependent on the requirements established, i.e., on what threat is to be stopped.

The layers of the first block (A) and the layers of the second block (B) may be amalgamated into a laminate by any suitable method.

Typically, the layers are joined to one another by an adhesion-promoting joining means.

In this context, the layers can be joined and held together by a frame or, advantageously, by extremely thin layers (≤0.8 mm, preferably ≤0.2 mm) of a suitable adhesive as the joining means. The use of such adhesives is common knowledge (EP 2 275 772 A1, U.S. Pat. No. 7,584,689 B2 and US 2009/0320675 A1).

An alternative possibility that also exists is to utilize adhesive-free, chemically activated mating (C. Myatt et al., Precision Photonics, Doc. #20060101), the applicability of which for polycrystalline (sintered) magnesium aluminate ceramics has been described by R. O. Loutfy (www.virtualacquisitionshowcase.com/document/1480/briefing). Specifically, the bonding of the butt joints of adjacent ceramic plates can also be generated by ceramic joining processes, as described for example in US 2011/0039094 A1 or for sapphire single-crystal plates by McGuire et al. (Proc. SPIE AeroSense Symposium, Orlando, FL, Apr. 16, 2001) or else by diffusion bonding, including, for example, laser-assisted diffusion bonding.

Suitable ceramics for the at least one layer of the second block (B) which comprises transparent ceramic include all ceramics which are suitable for laminated sheets for security applications.

Examples are monocrystalline magnesium aluminate spinel, colorless Al₂O₃ single crystals (sapphire or α-alumina), polycrystalline sintered ceramic of magnesium aluminate spinel, polycrystalline Al₂O₃ sintered ceramic and/or polycrystalline sintered ceramic of aluminum oxynitride.

The construction and the use of these ceramics in layers of laminated sheets for security application is described for example in U.S. Pat. No. 7,584,689 B2 and WO 2013/017448 A1.

Suitable glasses for the first block (A) and the second block (B) include all transparent glasses which are suitable for laminated sheets for security applications, preferably mineral glass, borosilicate glass, clear glass or glass with low iron content.

Suitable plastics for the first block (A) and the second block (B) include all transparent plastics which are suitable for laminated sheets for security applications. Particularly suitable is polycarbonate.

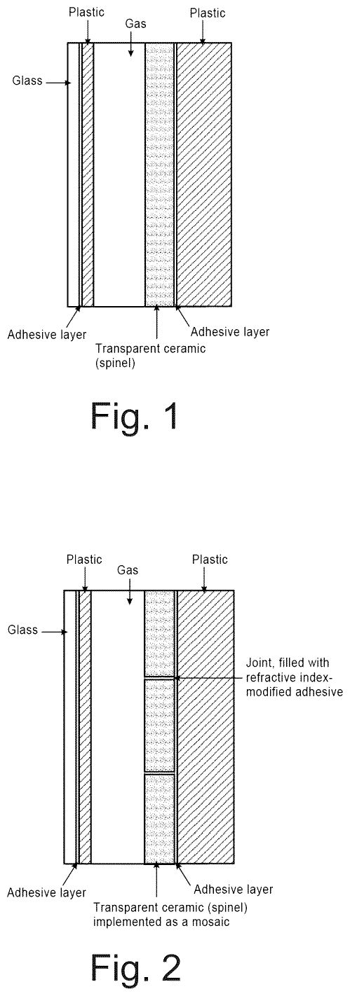

Preferred embodiments of the transparent laminated sheet of the invention are illustrated in FIGS. 1-4.

In a first preferred embodiment, illustrated in FIG. 1, the second block (B) consists of a layer of transparent ceramic, which is joined via an adhesive layer to a layer of plastic. The transparent ceramic is implemented as a continuous plate of for example magnesium aluminate spinel. The layer of transparent ceramic is in contact with the gas-filled compartment. The first block (A) consists of a layer of glass, which is joined via an adhesive layer to a layer of plastic. The layer of plastic is in contact with the gas-filled compartment.

In a second preferred embodiment, illustrated in FIG. 2, the second block (B) consists of one layer of transparent ceramic, which is joined via an adhesive layer to a layer of plastic. The transparent ceramic is implemented as a mosaic of for example magnesium aluminate spinel. The individual ceramic plates of the mosaic are joined to one another by a refractive index-modified adhesive in the joints between the plates. The layer of transparent ceramic is in contact with the gas-filled compartment. The first block (A) consists of a layer of glass, which is joined via an adhesive layer to a layer of plastic. The layer of plastic is in contact with the gas-filled compartment.

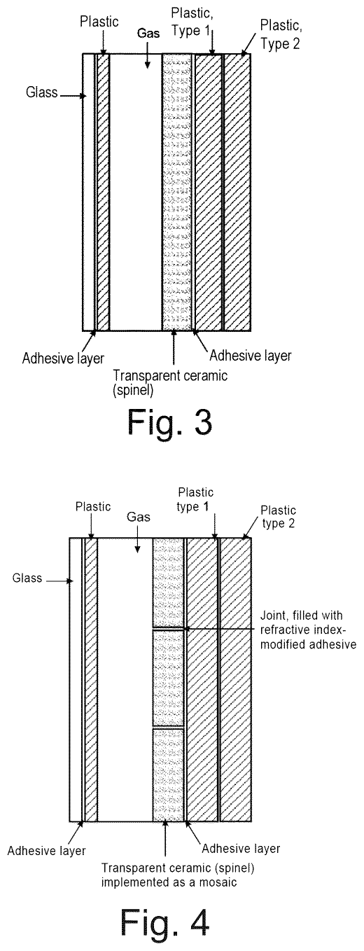

In a third preferred embodiment, illustrated in FIG. 3, the second block (B) consists of one layer of transparent ceramic and two layers of plastic. The layer of transparent ceramic is joined via an adhesive layer to a first layer of plastic. This first layer of plastic is joined in turn via an adhesive layer to a second layer of plastic. The two layers of plastic differ here in the type of plastic. The transparent ceramic is implemented as a continuous plate of for example magnesium aluminate spinel. The layer of transparent ceramic is in contact with the gas-filled compartment. The first block (A) consists of a layer of glass, which is joined via an adhesive layer to a layer of plastic. The layer of plastic is in contact with the gas-filled compartment.

In a fourth preferred embodiment, illustrated in FIG. 4, the second block (B) consists of one layer of transparent ceramic and two layers of plastic. The layer of transparent ceramic is joined via an adhesive layer to a first layer of plastic. This first layer of plastic is joined in turn via an adhesive layer to a second layer of plastic. The two layers of plastic differ here in the type of plastic. The transparent ceramic is implemented as a mosaic of for example magnesium aluminate spinel. The individual ceramic plates of the mosaic are joined to one another by a refractive index-modified adhesive in the joints between the plates. The layer of transparent ceramic is in contact with the gas-filled compartment. The first block (A) consists of a layer of glass, which is joined via an adhesive layer to a layer of plastic. The layer of plastic is in contact with the gas-filled compartment.

It has surprisingly emerged that a compartmentalized construction of the transparent laminated sheet of the invention as described herein, comprising two blocks separated from one another by a gas-filled compartment, affords effective protection from projectiles having a cemented carbide core, such as a tungsten carbide core, for example.

The function of the first block, which is composed of one or more layers of polycarbonate and glass joined to one another, is that of breaking open the projectile casing and stripping it back as far as possible, so that only the core of the projectile directly strikes the second block. The facing layer of the second block is formed by the transparent ceramic, which is joined by means of an adhesive layer to one or more layers of glass and/or polycarbonate. As a result, when it impacts on the ceramic, the tungsten carbide core is highly fragmented and the penetration capacity is greatly reduced.

The observation that the penetration depth of a projectile having a tungsten carbide core into a ceramic composite target decreases if the projectile casing is removed was described in P. J. Hazell, G. J. Appleby-Thomas, D. Philbey, W. Tolman, “The effect of gilding jacket material on the penetration mechanics of 7.62 mm armour-piercing projectile”, Int. Journal of Impact Engineering 54 (2013) 11-18.

As a result of this phenomenon, it is possible to use transparent laminated sheets having a weight lower by up to 30% as compared with laminated sheets having a facing layer comprising transparent ceramic, with the same effect.

The weight advantage is achieved by the arrangement according to the invention, including, in particular, when the ceramic lamina is implemented as a mosaic. In the case of direct hits on joints and edge regions of ceramic tiles, a lower protective effect is observed than in the case of hits in the central regions of the ceramic tiles. In order to be able to stop projectiles having a tungsten carbide core over the entire armored surface, therefore, the thickness of the ceramic tiles has to be increased.

This disadvantage is absent if the ceramic tiles are used as the facing layer of the second block in the compartmentalized construction according to the invention. If the projectile casing is stripped off from the tip of the tungsten carbide core when the first block is penetrated, the core undergoes severe fragmentation even in the case of hits on joints and edge regions of the transparent ceramic tiles. This means that, in this arrangement, the joints and edge regions of the ceramic tiles do not form ballistic weak points.

A further advantage of the arrangement according to the invention is that when the ceramic lamina is implemented as a mosaic, the joints are protected with respect to environmental influences. For a transparent laminated sheet to be used as the windshield in a vehicle, the joints between the ceramic tiles must be barely visible. This can be achieved through the use of an adhesive having a refractive index which is identical to or very close to that of the ceramic. The properties of such adhesives, however, may be adversely affected by environmental influences. By positioning the ceramic lamina in the interior of the laminated sheet, as in the compartmentalized arrangement according to the invention, the adhesive is protected against mechanical loads from the exterior.

The gas in the compartment could furthermore be used to reduce thermal loads on the adhesive layer.

The present invention additionally relates to the use of the transparent laminated sheet as described herein for security and/or protection applications for glazing or windows in the civil and military sectors.

In particular, the transparent laminated sheet of the invention as described herein can be used for security glazing or windows and/or protective glazing or windows in vehicles, flying objects or personal protection.

Here, the transparent laminated sheet of the invention as described herein advantageously affords protection from projectiles having a cemented carbide core, such as projectiles having a tungsten carbide core.

Projection from projectiles having a cemented carbide core means in this context that the transparent laminated sheet of the invention withstands the impact of projectiles having a cemented carbide core and prevents the transparent laminated sheet of the invention being breached.

In the further text, the invention is elucidated in more detail using a working example.

### Example

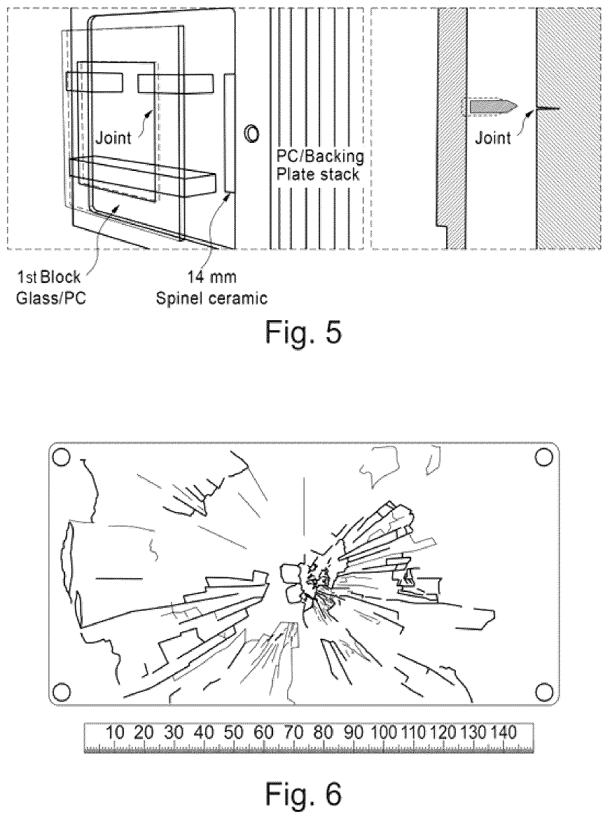

To test the effect of the stripped-off projectile casing of a projectile having a cemented carbide core in the context of the bombardment of joints, a joint was bombarded which had a leading, first block consisting of a glass plate 4 mm thick and a polycarbonate plate 5 mm thick. The second block consisted of two spinel plates 14 mm thick, disposed adjacent one another and joined by means of an adhesive layer to the following polycarbonate plate which was 20 mm thick. Behind this was a stack of multiple polycarbonate plates each 20 mm thick, to allow the residual penetration to be determined in the event of perforation of the compartmentalized target. The width of the joint between the plates was 0.3 mm. FIG. 5 shows, on the left, a photo of the target construction.

The x-ray flash exposure in the right-hand part of FIG. 5 shows the projectile just after it has breached the first block and is located in the space between the blocks. From the x-ray exposure (right) it is apparent that the projectile casing had been stripped back by the first block used and that the projectile struck the joint (visible as a dark strip) with a small offset.

On interaction with the target, the cemented carbide projectile core was completely fragmented, and no parts of the projectile penetrated the polycarbonate plate behind the spinel ceramic. This is illustrated by the photo of the polycarbonate plate after bombardment, in FIG. 6. On penetration of the projectile, the spinel ceramic was likewise highly fragmented, and the fragments parted from the polycarbonate plate. The radiant crack pattern is still perceptible on the polycarbonate plate. The dark adhesions on the polycarbonate plate are particles of the cemented carbide projectile core that had not penetrated into the polycarbonate.

1. A transparent laminated sheet for security applications, comprising a laminate of transparent layers in compartmentalized construction that comprises two blocks separated from one another by a gas-filled compartment,
wherein
the first block (A) comprises at least one transparent layer selected from glasses and plastics; and
the second block (B) comprises a laminate of at least two transparent layers selected from ceramics, glasses and plastics, wherein at least one layer of the second block (B) comprises transparent ceramic.

2. The transparent laminated sheet according to claim 1, wherein the transparent ceramic is selected from monocrystalline magnesium aluminate spinel, colorless Al₂O₃ single crystals (sapphire or α-alumina), polycrystalline sintered ceramic of magnesium aluminate spinel, polycrystalline Al₂O₃ sintered ceramic and polycrystalline sintered ceramic of aluminum oxynitride.

3. The transparent laminated sheet according to claim 1, wherein the at least one layer of the second block (B) which comprises transparent ceramic is composed of a plate of transparent ceramic, or of tessellated or serialized plates of transparent ceramic.

4. The transparent laminated sheet as claimed in claim 3, wherein the tessellated or serialized plates of transparent ceramic are joined to one another by an adhesion-promoting joining means.

5. The transparent laminated sheet according to claim 1, wherein the at least one layer of the second block (B) which comprises transparent ceramic has a thickness of 5 to 15 mm.

6. The transparent laminated sheet according to claim 1, wherein the layer of the second block (B) which comprises transparent ceramic is the layer of the second block (B) with contact to the gas-filled compartment.

7. The transparent laminated sheet according to claim 1, in which the layers of the first block (A) and/or the layers of the second block (B) are joined to one another by an adhesion-promoting joining means.

8. The transparent laminated sheet according to claim 1, wherein the first block (A) comprises a laminate of at least one layer of glass and at least one layer of plastic.

9. The transparent laminated sheet according to claim 1, wherein the second block (B) comprises the at least one layer which comprises transparent ceramic, and at least one layer of glass or of plastic.

10. A method comprising using the transparent laminated sheet according to claim 1 for security and/or protection applications for glazing or windows in the civil and military sectors.

11. The method according to claim 10, wherein the security and/or protection applications comprise windows in vehicles, flying objects or personal protection.

12. The method according to claim 10, wherein the protection applications comprise protection from projectiles with a cemented carbide core, such as projectiles with a tungsten carbide core.

13. The transparent laminated sheet according to claim 4, wherein the adhesion-promoting joining means has a refractive index matched to the transparent ceramic.

14. The method according to claim 12, wherein the projectiles with a cemented carbide core comprises a tungsten carbide core.
